(19) United States
(12) Patent Application Publication
(10) Pub. No.: US 2024/0375261 A1
(43) Pub. Date: Nov. 14, 2024

(54) ROTARY KNIFE HANDLE WITH KNUCKLE FASTENING

(71) Applicant: Diego-Alonso GARDUÑO-ARNAUD, Monterrey, Nuevo León (MX)

(72) Inventor: Diego-Alonso GARDUÑO-ARNAUD, Monterrey, Nuevo León (MX)

(21) Appl. No.: 18/684,623

(22) PCT Filed: Jul. 18, 2022
(86) PCT No.: PCT/MX2022/050063

§ 371 Date: Feb. 16, 2024

(30) Foreign Application Priority Data
Aug. 17, 2021 (MX) MX/U/2021/000458

(51) Int. Cl. B25G 1/10; B26B 3/00; F41B 13/00

(52) U.S. Cl. CPC B25G 1/102; B26B 3/00; F41B 13/00

(57) ABSTRACT

This invention relates to a rotating device which permits the reorientation of knives, mainly combat and survival knives, by forming part of the handle and characterized by gripping the knuckles of the hand. The device comprises: an axle which is anchored to the tang of the knife, the other end of which is shaped like a flattened disc to allow the knife to rotate, and the other end of which is shaped like a flattened disc to allow the knife to rotate.

The movable handle of the knife, which is characterized by containing a piece with an oval hole in longitudinal direction to capture the knuckles of the index, middle, ring and little fingers, and keep the hand attached to the handle while the knife is reoriented up and down and vice versa. In addition, it contains a slotted magnet that prevents twisting of the movable handle when the weapon is holstered.

The present utility model is related to knives in general and more specifically with a device for gripping and reorienting combat knives, quickly, with one hand and in accordance with knife fighting techniques, said device forming the hilt of the knife and having an integrated knuckle grip. Device made essentially, but not exclusively, of wood and/or metal.

### BACKGROUND

As can be seen with reference to the following U.S. Pat. Nos. 4,087,911; 4,283,854; 4,034,982; 2,359,098, 4,920,648, 5,005,292A, the prior art features various handgun devices as well as a rotary grip device.

Although the creations of the above technique may be fit for purpose, they are far from provide the ideal combat weapon, particularly to: facilitate the quick one-handed grip, draw and holster; allow for a correct combat grip; and provide a firm and secure fulcrum for the integrity of the hand. All this, with the possibility of an easy and simple reorientation of the weapon, depending on the attack or defense to be performed.

Devices created using the above technique comprise gripping appendages that receive the fingers through one or two rings to ensure the basic retention of the weapon and its reorientation; however, it is not taken into account that in combat, tactical gloves are usually used, so it would be almost unfeasible to use the weapon, or that changes in ambient temperature or a blow to the weapon could cause the weapon to be damaged, unexpectedly on the fingers could affect its volume, and since the fit to the fingers must be almost exact, the grip unit would become a hindrance, since it could not be used effectively the finger holes and the presence of the gripper unit would make it uncomfortable to use the knife effectively. In addition, the use of rings as part of the devices requires looking away from the weapon in order to insert the fingers, and the location of the rings makes it difficult to grip

The knife correctly and comfortably, reducing the force that can be applied to the grip.

The foregoing, implies the need for an improved construction of a knife that allows knife reorientation and incorporates safety, convenience and efficiency; the development of such a device being the stated purpose and objective of the present utility model.

### DESCRIPTION OF THE INVENTION

The utility model on the rotating knife grip arrangement by means of knuckle gripping, which forms the basis of the present invention, comprises in general: a grip unit (1) fixed to the spigot, a gripper unit (2) movable and a shaft unit (3) coupled between the two gripper units and associated such that the movable gripper unit can rotate about its axis.

In essence, the main objective behind the development of the present utility model, is to provide carriers with a safe, efficient, fast and comfortable means, of grasping and maintaining the grip of a knife while the carrier can reorient the knife, allowing to perform the correct hand posture on the knife handle, in accordance with knife fighting techniques, which in turn, allows greater strength to be applied to the grip.

For this purpose, attached to the tang, in the middle and central part of the handle, the shaft unit is located. From said shaft unit, the movable grip unit located on the handle on the knife edge side is attached. The shaft has at one end a flat disc shape, with an axial length that is less than the thickness of the knife handle, this flat disc shape allows and promotes turning.

At the other end of the shaft, it is shaped to allow the part to be anchored to the fixed gripping unit. This is mounted on the spigot perpendicularly, and fixed by means of a screw transversely.

The mobile gripping unit comprises in general: four pieces, where, in the preferred embodiment of the invention, the first one has a longitudinal concavity on the side opposite the heel, to integrate a third part which is a slotted magnet. This magnet prevents the mechanism from rotating when the gun is sheathed or is not gripped by the handle. The first piece, likewise, has another longitudinal concavity on the side of the heel of the knife, which allows to fix a fourth piece. This fourth piece, which has the shape of an oval ring, has the main function of containing the knuckles of the hand (specifically the area of the proximal interphalangeal joints of the index, middle, ring and index fingers and of holding the knuckles of the hand, little finger, although it could function without including all of these fingers) keeping it attached to the grip and permitting a proper grip, in accordance with classic knife fighting techniques. The first and second pieces have a concavity in the middle inner part which serves as an axis catch when they are joined together, by means of a plurality of suitable fastening means such as screws are joined together, by means of a plurality of suitable fastening means such as screws, or the like, which pass transversely in relation to the blade of the knife. The captured shaft is in the shape of a flattened disc, so as to allow rotation and is sized so that it cannot pass through the smaller diameter portions of the slid opening.

The fixed gripping unit comprises in general: two pieces, where, in the preferred embodiment of the invention, each is disposed on opposite sides of the knife, joined by means of a plurality of suitable fastening means such as screws, or the like, passing transversely in relation to the knife blade, to contain and secure the tang between them, as well as the lower part of the axle unit.

### DESCRIPTION OF THE FIGURES

In order to give concrete expression to the advantages briefly mentioned above, to which users and those skilled in the art may add more, a preferred example of realization is described below, which is illustrated schematically and without any particular scale in the attached drawings, with the express clarification that, as it is an example, it is not appropriate to assign to it an exclusive or limiting character of the scope of protection of the present, but simply to assist it a merely explanatory and illustrative of the basic line on which it is based. In these drawings, the:

FIG. 1: is a perspective view of a combat knife, including the knuckle-holding swivel grip device.

FIG. 2: is an exploded perspective view showing the main parts of a knife. combat, including the rotating handle device and the shaft connecting them.

FIG. 3: is a side view of a knife with a knuckle-grip rotating handle device.

FIG. 4: is a top plan view of a knife with a knuckle-grip rotating handle device.

FIG. 5: is a longitudinal cutaway view of a knife with a knuckle-holding rotating handle device.

FIG. 6: is an exploded perspective view showing the constituent parts of a combat knife, including the knuckle-holding rotating hilt device.

FIG. 7: A top plan view of a combat knife with a swivel hilt by means of knuckle clamping, in the form of a double “m”.

FIG. 8: is a perspective view of a combat knife with a knuckle-holding, double “m” shaped, rotating hilt.

### BEST KNOWN METHOD FOR CARRYING OUT THE INVENTION

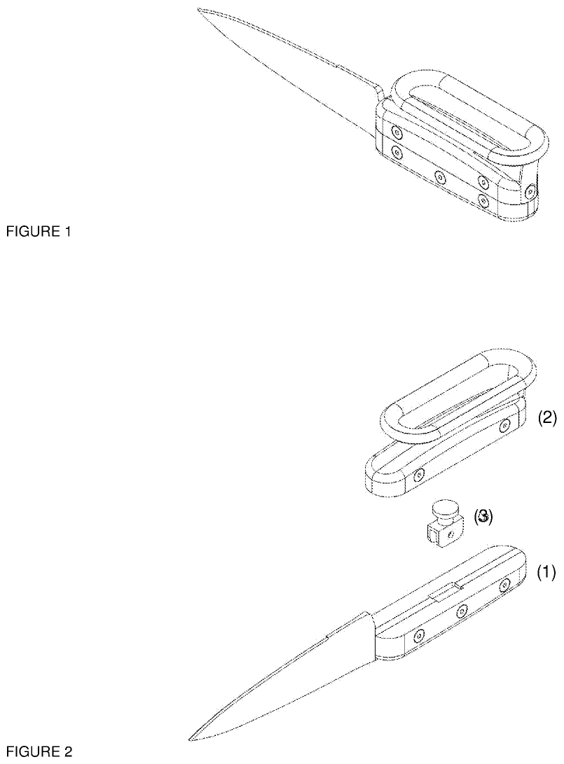

In order to associate the figures mentioned with the description that will follow, reference numbers have been used. As can be seen with reference to the figures and, in particular, with reference to FIGS. 1 AND 2, the gripping arrangement forming the basis of the present invention comprises in general: a gripping unit fixed to the spigot (1); a movable gripping unit (2); and a shaft unit (3) by means of which the two gripping units are operatively connected to each other and coupled to the spigot of a combat knife.

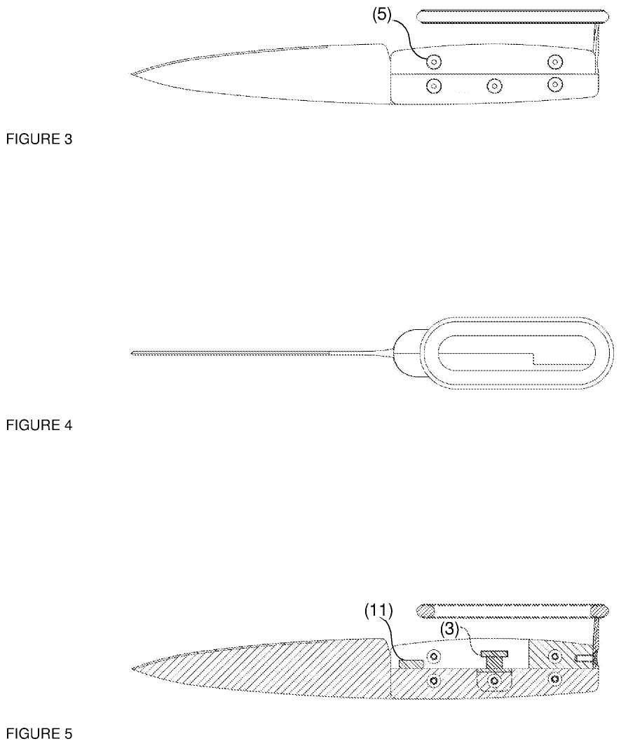

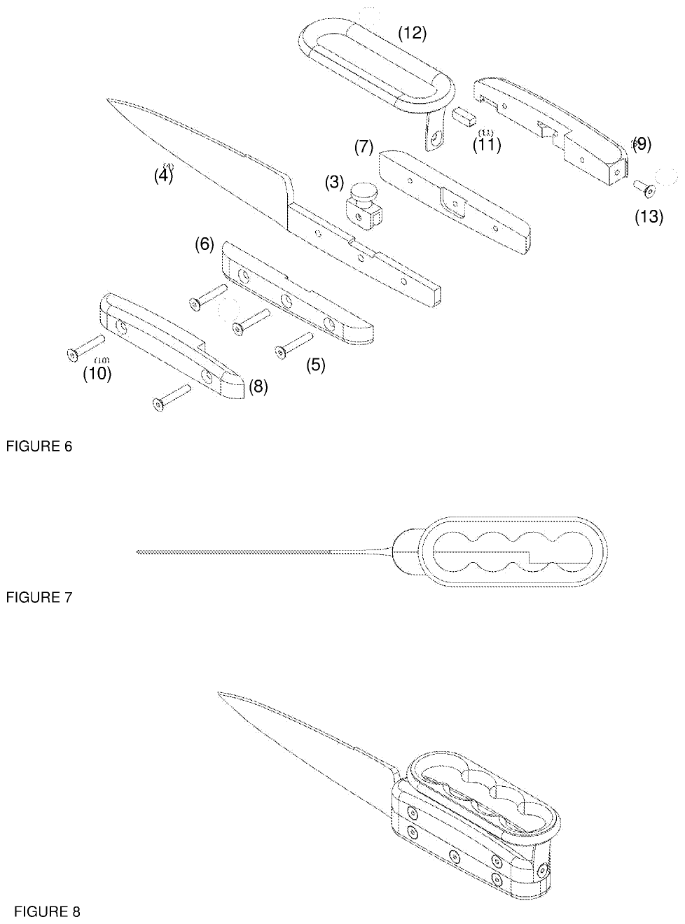

As can best be seen with reference to FIGS. 2 to 6, the combat knife construction comprises a knife tang (4) which is coupled and sandwiched between the two parts, (6) (7) which constitute the fixed gripping unit (1). The shaft unit (3) is also coupled and sandwiched between the two parts of the fixed gripping unit (1) and all these elements are operatively secured to each other and coupled to the spigot by means of a plurality of means of suitable fasteners (5) such as screws, or the like which extends through the gripping unit in a transverse direction to the knife, reaching their final position when meeting the workpiece (7).

As shown in FIGS. 2 to 6, the movable gripping unit (2) generally comprises two parts (8) (9) which are operatively secured to each other by means of a plurality of means suitable fasteners (10) such as screws, or the like, extending through the unit, such as screws, or the like the gripping unit is mounted in a transverse direction and reaches its final position when it meets the part (9). The parts (8) and (9) joined together have the function of containing the upper part of the shaft unit (3), so as to allow rotation with respect to the fixed gripping unit (1). In addition to containing the axle unit (3), the union of the parts (8) and (9) also contain at least one part with magnetic qualities (11) such as a slotted magnet, or similar, which serves the function of securing to the movable gripper unit (2) and position it longitudinally to the knife due to the physical properties of attraction with the metal pin (4). To this group of parts of the movable gripper unit (2) is provided with a part (12) which has the main function of containing the knuckles and keeping 25 the hand attached to the handle. This piece (12) is coupled to the piece (9) by means of some suitable fastening (13) such as screw, or the like, extending through the gripping unit longitudinally to the knife.

As seen in the figures, the shaft unit (3) is comprised of at least one piece, where, in the preferred embodiment of the invention, a shaft which in the upper part is with a flat disc shape to allow and favor the opposite rotation between the fixed grip unit (1) and the unit of movable grip (2), while at the lower part of the shaft (3) it is shaped such that. allows it to be anchored to the fixed gripping unit (1) and, consequently, to the spigot (4).

From the figures, it is pertinent to note that the present arrangement not only allows the combat knife to rotate relative to the user's hand (not shown); but also, that the knuckle-holding piece (12) also serves as a finger and knuckle guard. In this particular version, the oval ring serving to capture knuckles (12) comprises a longitudinally enlarged diameter hole sufficiently long to capture the knuckles of the index, middle, ring and little fingers, however, in another version (not shown) the length may be shorter to capture fewer knuckles of the hand, without affecting the operation of the device or its rotation.

In FIGS. 7 and 8, an alternative to the oval ring for knuckle support is shown, this option comprises a series of four holes linked together and arranged lengthwise in a double “m” shape to ergonomically fit the index, middle, ring and little fingers, however, in another version (not shown) the series of holes can be three to capture the knuckles of the middle, ring and little finger, without affecting the operation of the device.

I claim:

1. A device in rotatable grip in combination with a knife, primarily for combat and/or survival, comprising a tang having a sharp point, the sharp blade having at least one dull surface near the hilt, and a knife handle having grip units aligned to the tang, wherein the device comprises:
a. A fixed gripping unit, consisting of two parts arranged on the sides of the knife and joined together grouping and containing fixed to the shank and the lower part of the shaft unit;
b. A shaft unit, consisting of a shaft-shaped part, the lower part of which is shaped in such a way that it can be anchored to the fixed gripping unit, and which at the top of which at the top of the shaft is in the shape of a flat disc for to allow and promote the rotation of the mobile gripping unit;
c. A movable gripping unit, consisting of two parts that are operatively secured to each other and serve the function of containing the upper part of the shaft unit allowing rotation; they also contain a slotted magnet that prevents the mechanism from turning when the gun is holstered or is not gripped by the Finally, a piece is added to the unit that has the main function of containing the knuckles and keeping the hand attached to the handle, characterized by having an oval hole in longitudinal direction sufficiently long to capture the knuckles of the index, middle, ring and little fingers.

2. A rotatable knife handle device according to claim 1, characterized in that the knuckle grabber.
The knuckle grabber is able to perform a rotary and reciprocating motion with respect to the blade.

3. A rotating knife handle device according to claim 1, wherein the part added to the movable grip unit to contain the knuckles and keep the hand attached to the handle is characterized by having an oval hole sufficiently long and shaped to fit the knuckles of the index, middle, ring and little finger.

4. A rotating knife grip device according to claim 1, wherein the part added to the movable grip unit for containing the knuckles and holding the hand attached to the handle, is characterized by having an oval hole of shorter length for capture only the middle, ring and pinky fingers, without affecting the operation of the device.

5. A rotating knife grip device according to claim 1, wherein the part added to the movable grip unit for containing the knuckles and holding the hand with the handle, is characterized by a succession of four holes connected to the handle, which are the knuckles of the index, middle, ring and little fingers are ergonomically positioned in a double “m” shape, arranged lengthwise to fit the knuckles of the index, middle, ring and little fingers.

6. A rotating knife grip device according to claim 1, wherein the part added to the movable grip unit for containing the knuckles and holding the hand The handle is characterized by having a coupling method that allows for exchange for another piece of smaller or larger size according to the size of the wearer's hand.
